(19) United States
(12) Patent Application Publication
(10) Pub. No.: US 2014/0045386 A1
(43) Pub. Date: Feb. 13, 2014

(54) Connector and Manufacturing Method Thereof

(71) Applicant: Tyco Electronics Japan G.K., Kanagawa (JP)

(72) Inventor: Takeshi Kimura, Kanagawa (JP)

(73) Assignee: Tyco Electronics Japan G.K., Kanagawa (JP)

(21) Appl. No.: 14/058,823

(22) Filed: Oct. 21, 2013

Related U.S. Application Data
(63) Continuation of application No. PCT/JP2012/059318, filed on Apr. 5, 2012.

(30) Foreign Application Priority Data
Apr. 20, 2011 (JP) 2011094258

(51) Int. Cl. H01R 9/24; H01R 43/00

(52) U.S. Cl. CPC H01R 9/24; H01R 43/00
USPC 439/709; 29/876

(57) ABSTRACT

A connector having an insulating body with an outer surface and an inner surface. A receiving passageway extends through the insulating body from the outer surface to the inner surface. A sealed conductor is positioned in the receiving passageway. An outer conductive pad is positioned on the outer surface and connected to the sealed conductor. An inner conductive pad positioned on the inner surface and connected to the sealed conductor. A contact member is disposed on at least one of the conductive pads and has a fixed region positioned on at least one of the conductive pads and a contact region that extends from the fixed region.

### CROSS-REFERENCE TO RELATED APPLICATIONS

This application is a continuation of PCT International Application No. PCT/JP2012/059318, filed Apr. 5, 2012, which claims priority under 35 U.S.C. §119(a)-(f) to Japanese Patent Application No. 2011-094258, filed on Apr. 20, 2011.

### FIELD OF THE INVENTION

The present invention includes an electrical connector for serving an electrical connection in a device having a vacuum chamber and a manufacturing method thereof

### BACKGROUND

Japanese Patent Application JP 2004-349073A discloses a conventional electrical connector for devices having vacuum chambers. This connector includes a board positioned within an opening in the vacuum chamber wall in such a way as to a seal the opening and prevent air leakage into the chamber. The connector includes inner and external conductor pads connected to each other through passageways extending between the an inner surface and an external surface of the board. The connector uses inner and external spring contacts to the inner and external conductor pads. A board type connector uses spring contacts to attach to the inner and external conductor pads of the board.

A disadvantage of the board type connector is that the spring contacts attach to the conductor pads orthogonally to both the inner and outer surfaces of the board. The result is that the conventional electrical connector is not low profiled, and requires a large amount of space.

### SUMMARY

In view of the foregoing, it is therefore an object of the present invention, among others, to provide a low profiled electrical connector for use in vacuum chamber devices, and a manufacturing method thereof

A connector having an insulating body with an outer surface and an inner surface. A receiving passageway extends through the insulating body from the outer surface to the inner surface. A sealed conductor is positioned in the receiving passageway. An outer conductive pad is positioned on the outer surface and connected to the sealed conductor. An inner conductive pad positioned on the inner surface and connected to the sealed conductor. A contact member is disposed on at least one of the conductive pads and has a fixed region positioned on at least one of the conductive pads and a contact region that extends from the fixed region.

### BRIEF DESCRIPTION OF THE DRAWINGS

FIG. 1 is a perspective view illustrating a connector of a first embodiment according to the present invention;

FIG. 2 is a plan view illustrating the connector of the first embodiment according to the present invention;

FIG. 3 is a front view illustrating the connector of the first embodiment according to the present invention;

FIG. 4 is a side view illustrating the connector of the first embodiment according to the present invention;

FIG. 5 is a bottom view illustrating the connector of the first embodiment according to the present invention;

FIG. 6 is a side sectional view of the connector illustrated in FIGS. 1 to 5;

FIG. 7 is a view explaining manufacturing steps of the connector illustrated in FIGS. 1 to 6;

FIG. 8 is a schematic diagram illustrating an application example of the connector 1 illustrated in FIGS. 1 to 6; and

FIG. 9 is a perspective view illustrating an appearance of a connector as a second embodiment according to the present invention.

### DETAILED DESCRIPTION OF THE EMBODIMENT(S)

Embodiments according to the present invention will be described with reference to the attached drawings.

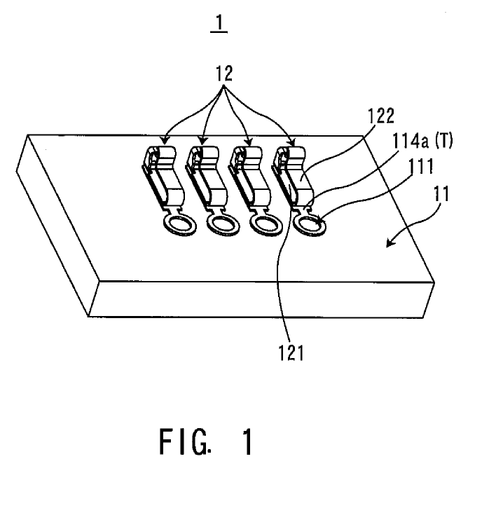

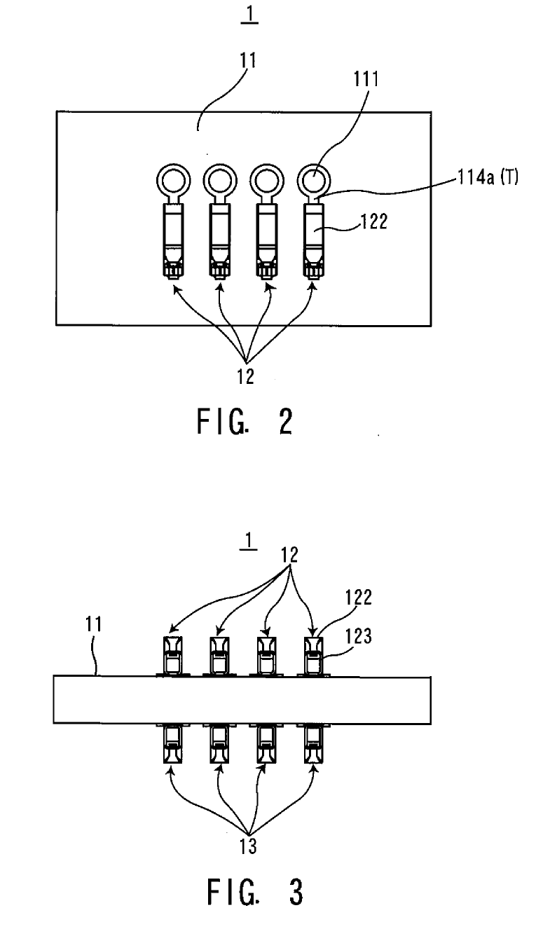

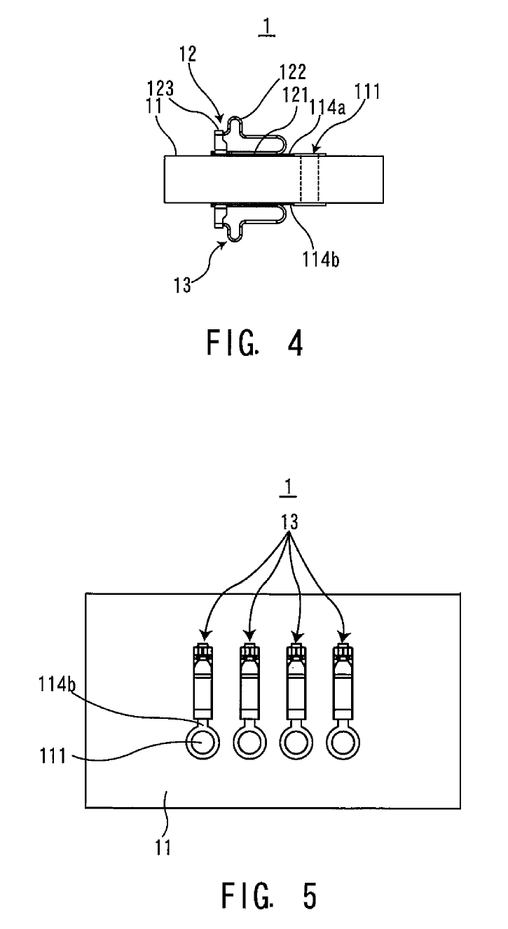

The connector 1 illustrated in FIGS. 1 to 6 is a sealed electrical connector for use in devices with a vacuum chamber. The connector 1 includes an insulating body 11, an outer contact member 12, and an inner contact member 13.

The insulating body 11 is a plate formed from an insulating material. Embodiments of the insulating material include glass impregnated epoxy resin. However, in other embodiments, the insulating material can be phenol resin, glass or ceramic.

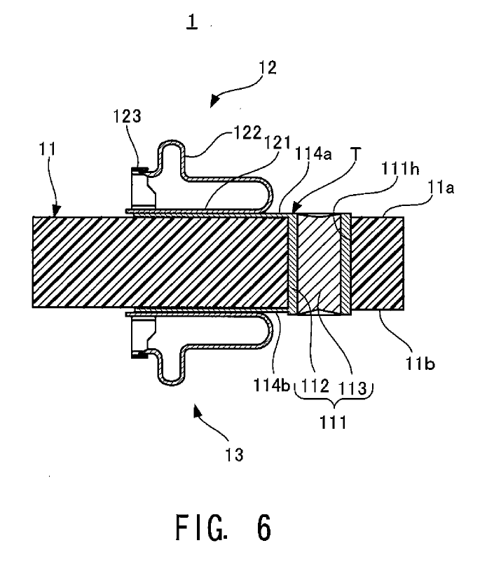

The insulating body 11 has an outer surface 11a and an opposing inner surface 11b with sealed conductors 111 extending through the insulating body 11 from the outer surface 11a to the inner surface 11b. As illustrated in FIG. 6, the sealed conductors 111 are positioned in receiving passageways 111h that extend through the insulating body 11 from the outer surface 11a to the inner surface 11b, and form a seal while maintaining electrical conductivity.

Each of the sealed conductors 111 includes a conductive member 112 and a sealant 113. The conductive member 112 is a sleeve disposed along the entire surface of the inner walls of each of the receiving passageways 111h. The sealant 113 completely fills a central portion of the conductive member 112 to form an airtight seal along the length of the conductive member 112, and by extension, along the length of the receiving passageway 111h. Since the sealant 113 forms an airtight seal along the length of the conductive members 112, even if a pressure difference is generated between the outer surface 11a and the inner surface 11b, air is unable to pass through the receiving passageway 111h.

In an embodiment, the conductive member 112 is made of copper. In other embodiments, the conductive member 112 includes other electrically conductive materials such as silver, brass, or aluminum.

In an embodiment, the sealant 113 includes solder whose main component is tin. However, in other embodiments, the solder can include other main components, such as alloys like aluminum or silver.

Outer conductive pads 114a and inner conductive pads 114b connect to each of the respective conductive members 112 through conductor traces T. The outer conductive pad 114a is positioned on the outer surface 11a and connects to an outer surface edge of the conductive member. The inner conductive pad 114a is positioned on the inner surface 11b and connects to an inner surface edge of the conductive member. The conductive pads 114a, 114b are formed of the same material as that of the conductive members 112, and extend from the conductive members 112 along on the outer surface 11a and the inner surface 11b, respectively.

Conductor traces T are positioned on both the outer surface 11a and the inner surface 11b between the conductive member 112 and the outer conductive pad 114a and the inner conductive pad 114b, respectively. The conductive traces T, the conductive member 112 and the conductive pads 114a, 114b are formed as single-piece plating films by plating on the insulating body 11 in which the receiving passageways 111h are formed.

The outer contact member 12 is disposed on an outer conductive pad 114a connected to the conductive trace T positioned on the outer surface 11a. The inner contact member 13 is disposed on an inner conductive pad 114b connected to the conductive trace T positioned on the inner surface 11b.

An embodiment of the connector is illustrated in FIG. 1 as a four-position connector. Four sealed conductors 111 are positioned in four receiving passageways 111h in the insulating body 11. Four outer contact members 12 are positioned on the outer surface 11a of the insulating body 11, and four contacts members 113 are arranged on the inner surface 11b of the insulating body 11. Since the contact members 112 on the outer surface 11a have configurations same as those of the contact members 113 on the inner surface 11b, the outer contact members 12 on the outer surface 11a will be described, representing them.

The outer contact member 12 is formed by stamping and forming a continuous electrically conductive metal plate. The outer contact member 12 includes a fixed region 121 positioned on the conductive pad 114a, a U-shaped bend, and a contact region 122 contactable with a mating component (not illustrated). The fixed region 121 is a planar portion connected to the conductive pad 114a by solder or electrically conductive adhesive. At one end, the fixed region 121 bends away from the insulating body 11 to form a U-shaped bend and the contact region 122. The contact region 122 extends away from the U-shaped bend, parallel with the planar fixed region 121 for a distance. In an embodiment, a U-shaped projection extends outward from a terminal end of the contact region 122, away from the insulating body 11 and fixed region 121. In other embodiments, the projection shape of the contact region 122, can be shapes other than the shape illustrated in the drawings. For example, squared, triangular, oval, circular, or rectangular shapes may also be used.

The U-shaped bend creates a spring-bias in the contact region 122. When the mating component contacts the contact region 122 with a directional force towards the insulating body 11, the spring-bias of contact region 122 exerts an opposing directional force against the directional force of the mating component to form a constant electrical contact.

The outer contact member 12 also includes a preload region 123 at the terminal end of the contact region 122. The preload region 123 engages an inner surface of a catch (not labeled), which catches and holds the contact region 123 under a constant tension from the spring -bias created by the U-shaped bend in the absence of an applied force by the mating component. When the mating component exerts a force on the contact region 122, and the contact region 122 only slightly deformed to an extent to which the contact region 122 and preload region 123 separate from the catch. The effect is that the contact region 122 applies a force in the opposite direction to that applied by the mating component with a force greater than the force exerted on the catch by the preload region 123.

However, as the shapes of the contact regions 122, shapes other than the shape illustrated in the drawings, for example, ones in which whole portions further onward from the curving of the fixed regions 121 swelling in an arcuate manner can be used.

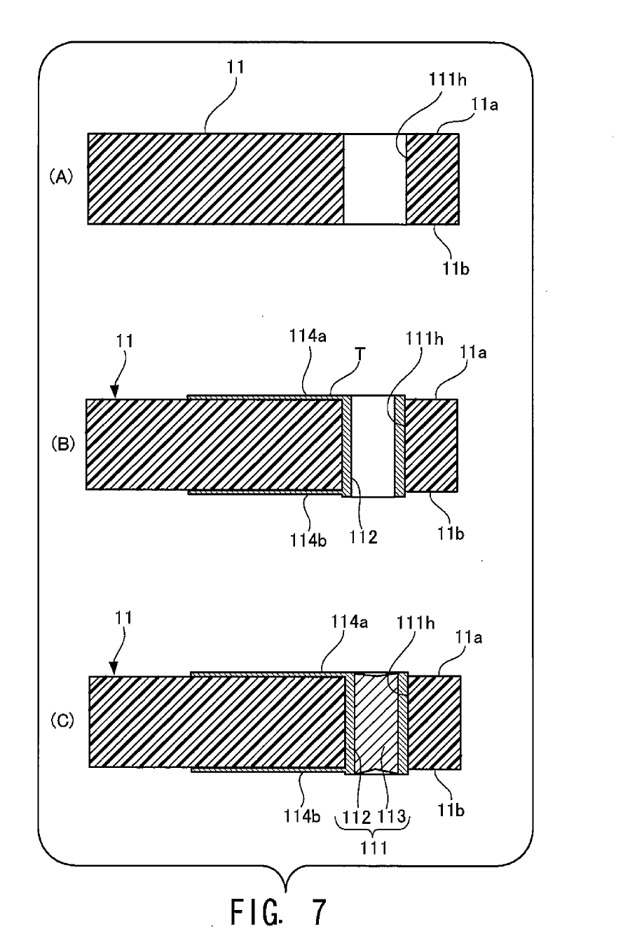

FIG. 7 includes parts (A) to (D) sequentially illustrating steps for manufacturing the connector.

First, the receiving passage 111h is bored through the insulating body 11 from the outer surface 11a to the inner surface 11b. (FIG. 7(A))

Next, the conductive trace T is plated onto the insulating body. (FIG. 7(B)) The conductive trace T integrally includes the conductive member 112 covering the inner wall surface of the receiving passageway 111h, and the conductive pads 114a, 114b extending on the outer surface 11a and the inner surface 11b respectively continuing from the conductive member 112.

Next, the receiving passageway 111h, whose inner wall surface is covered with the conductive member 112, is filled with the sealing material 113 to seal the receiving passageway 11h and form the sealed conductor 111. (FIG. 7(C))

Next, in an attaching step, as illustrated in FIG. 6, the contacts members 12, 13 are soldered to the conductive pads 114a, 114b of the conductive trace T, respectively. Thus, the connector 1 illustrated in FIGS. 1 to 6 is completed.

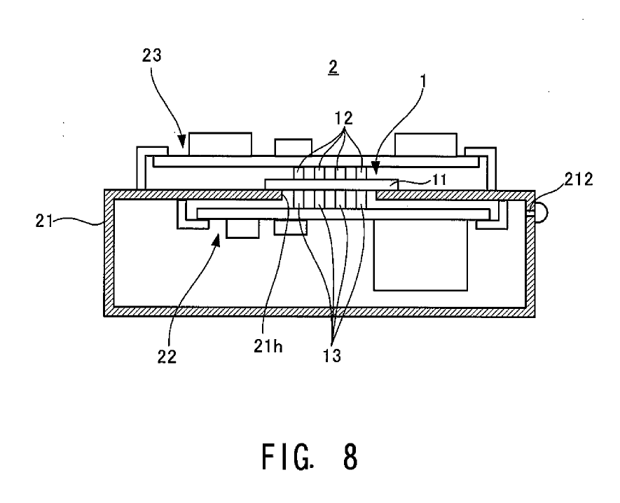

A device 2 illustrated in FIG. 8 is a chamber device operating in an atmosphere where a pressure and composition are adjusted. More specifically, the device 2 includes a partition wall 21, an internal circuit board 22, an external circuit board 23 and the connector 1 illustrated in FIGS. 1 to 6.

The partition wall 21 is a container providing a partition between an external space and an internal space. The internal circuit board 22 is disposed on an inside surface of the partition wall 21, inside the container. The internal circuit board 22 includes electronic components and mechanical devices mounted thereon which operate in a vacuum atmosphere or a pressurized atmosphere. The partition wall 21 includes a wiring opening 21h for wiring. The connector 1 is attached to the partition wall 21 such that the insulating body 11 closes the wiring opening 21h. The space between the insulating board 11 of the connector 1 and the partition wall 21 is filled with sealing material (not illustrated).

The external circuit board 23 is disposed outside the partition wall 21, and supplies electric power to the internal circuit board 22 and also controls the internal circuit board 22. The internal circuit board 22 and the external circuit board 23 are mating components to which the connector 1 is connected. The internal circuit board 22 and the external circuit board 23 are electrically connected with each other through the connector 1. The internal circuit board 22 and the external circuit board 23 are held by the partition wall 21 such that the internal circuit board 22 and the external circuit board 23 press the contact members 12, 13 toward the insulating board 11.

The connector 1 is fastened over an opening in the partition wall 21 and sealed to prevent air or gas from passing into or out of the container. The internal pressure of the container is controlled through a port 212. The electrical components or the mechanical devices on the internal circuit board 22 can operate in a vacuum or under a pressurized atmosphere inside the container.

As illustrated in FIG. 6, the receiving passageways 111h are sealed by the sealed conductors 111, and air pressure is retained between the outer surface and the inner surface corresponding to the outside and the inside of the partition wall 21. More specifically, since the receiving passageway 111h are respectively sealed by the conductive member 112 and the sealant 113 welded to the conductive members 112, gas leakage does not occur even when there is a pressure difference between the outside and the inside of the partition wall 21. The contact member 12, 13 can be positioned approximately in parallel with the insulating body 11 such that the internal circuit board 22 having the plate shape and the external circuit board 23 abut on the contact regions 122. Accordingly, the connection configuration can be low profiled, compared to a conventional connector in which a board type connector is attached in a direction perpendicular to an insulating board.

When the internal circuit board 22 or the external circuit board 23 is subjected to an impactive force parallel to the insulating body 11, such as a vibration, the spring-bias of the contact regions 122 allows the contact regions to bend towards or away from the insulating body 11, while still maintaining contact with the internal circuit board 22 or the external circuit board 23.

When the internal circuit board 22 or the external circuit board 23 is subjected to an impactive force perpendicular to the insulating body 11, the contact regions 122 are elastically deformed to absorb the impactive force, and prevents the impactive force from transferring to the insulating body 11 and the sealed conductors 111 in the receiving passageways 111h. Accordingly, the sealed conductors 111 avoid being damaged by the perpendicular force, the container remains sealed.

Next, a second embodiment according to the present invention will be described. In the following description of the second embodiment, elements same as those of the above-described embodiment are provided with the same symbols, and differences from the above-described embodiment will be described.

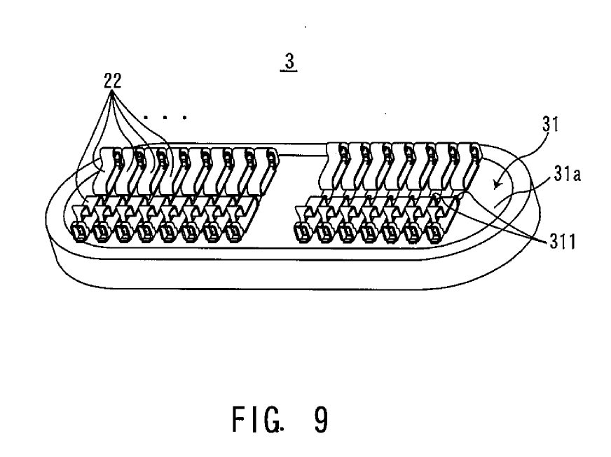

In another embodiment, the connector 3 illustrated in FIG. 9 includes an insulating body 31 having an oblong circular plate shape. In order to secure the air tightness between the connector 3 and the partition wall 21 (see FIG. 8) when the connector 3 is attached to the partition wall 21, an O ring (not illustrated) is attached on an inner or outer surface edge of the oblong circle in the insulating board 31. The connector 3 of the second embodiment is a thirty-position connector. Thirty contact members 22 are arranged on an outer surface 31a of the insulating body 31 in the connector 3. In addition, thirty contact members are also arranged on a inner surface in the connector 3, while not being illustrated. The contact members 22 on the outer surface and the contact members on the inner surface are electrically connected with each other via thirty sealed conductors 311 (A part of them is illustrated in the drawing.) provided in the insulating body 31. Individual configurations of the contact members 22 and the sealed conductors 311 are similar to those in the first embodiment described with reference to the FIGS. 1 to 6.

The connector 3 of this embodiment can transfer more electrical signals, compared to the connector of the first embodiment.

Incidentally, in the application example illustrated in FIG. 8, the internal circuit board 22 and the external circuit board 23 are connected to the connector 1. However, a cable represented by FFC (Flexible Flat Cable) and FPC (Flexible Printed Circuit) may replace either circuit board 22,23 or both circuit boards 22,23 and be connected to the connector.

In addition, in the above-described embodiments, as examples of the contact members, contacts members arranged on both of the outer surface and the inner surface of the insulating body are described. However, the present invention is not limited to this. For example, the contact members are on one of the top surface and the inner surface, and the other of them may be provided with only the conductive pads, to which a mating component is directly connected. In this embodiment, the mating component may be soldered directly to the conductive pad and replace the contact member 12, 13.

In addition, in the above-described embodiments, as examples of the connector according to the present invention, a four-position connector and a thirty-position connector are described. However, the present invention is not limited to this. For example, the number of the positions, i.e., the sealed conductors, of the connector may be a value other than four and thirty, such as 1-3, 5-29, or more that 30 and the contact members may be accommodated in a housing.

In addition, each of the elements in the above-described embodiments may exchanged with each other. For example, the shape of the insulating body in the first embodiment may be an oblong circular shape as described in the second embodiment.

Further, in the above-described embodiments, the receiving passageways 111h extend linearly in an up-and-down direction. However, the receiving passageways 111h may couple the outer surface 11a and the inner surface 11b in a zigzag manner.

In addition, the sealants 113 may be an insulating sealing material, such as Torr Seal™, and may be applied in the receiving passageways 111h to close the receiving passageways 111h.

Further, the contact members may be positioned close the sealed conductors, and may include portions extending inside the receiving passageways 111h, respectively. In the latter case, there is an advantage that a connection strength between the contact member and the through hole (the through section) is enhanced.

Furthermore, the direction in which the contacts members are pressed by the mating component to be elastically deformed are not only one approximately perpendicular to the top surface and the inner surface of the insulating body as described above, but also may be one oblique with respect to the top surface and the inner surface of the insulating body.

What is claimed is:

1. A connector, comprising:
an insulating body having an outer surface, an inner surface, a receiving passageway extending through the insulating body from the outer surface to the inner surface, a sealed conductor positioned in the receiving passageway, an outer conductive pad positioned on the outer surface and connected to the sealed conductor, and an inner conductive pad positioned on the inner surface and connected to the sealed conductor; and
a contact member disposed on at least one of the conductive pads and having a fixed region positioned on at least one of the conductive pads and a contact region that extends from the fixed region.

2. The connector according to claim 1, wherein the contact region is spring-biased.

3. The connector according to claim 1, wherein the contact region has a projection extending outward from a terminal end of the contact region.

4. The connector according to claim 1, wherein the contact member further comprises a U-shaped bend between the fixed region and the contact region.

5. The connector according to claim 1, wherein the sealed conductor comprises a conductive member disposed on a surface of the inner wall of the receiving passageway.

6. The connector according to claim 5, wherein the outer conductive pad is connected to an outer surface edge of the conductive member.

7. The connector according to claim 6, further comprising a conductive trace between the outer conductive pad and the conductive member.

8. The connector according to claim 5, wherein the inner conductive pad is connected to an inner surface edge of the conductive member.

9. The connector according to claim 8, further comprising a conductive trace between the inner conductive pad and the conductive member.

10. The connector according to claim 5, wherein the sealed conductor further comprises solder disposed in a central portion of the conductive member to form an airtight seal.

11. A method of manufacturing a connector, comprising:
boring a receiving passageway from an outer surface to an inner surface of an insulating body;
plating a conductive member on an inner wall surface of the receiving passageway and conductive traces on the top surface and on the inner surface;
filling the receiving passageway with sealing material to seal the receiving passageway; and
attaching a fixed region of a contact member to at least one of the top surface conductive trace and the inner surface conductive trace.
